(19) United States
(12) Patent Application Publication
(10) Pub. No.: US 2009/0253028 A1
(43) Pub. Date: Oct. 8, 2009

(54) TEMPERATURE ADJUSTMENT MECHANISM AND VEHICLE

(76) Inventor: Masaru Takagi, Aichi-ken (JP)

Correspondence Address: KENYON & KENYON LLP, 1500 K STREET N.W., SUITE 700, WASHINGTON, DC, 20005, US

(21) Appl. No.: 12/305,220

(22) PCT Filed: Feb. 14, 2008
(86) PCT No.: PCT/IB08/00342

§ 371 Date: Dec. 17, 2008

(30) Foreign Application Priority Data
Feb. 20, 2007 (JP) 2007-038883

(51) Int. Cl. H01M 10/50

(52) U.S. Cl. 429/62

(57) ABSTRACT

A temperature adjustment mechanism has an electric power supply device, and a member that is provided between and in contact with the electric power supply device and a heat transfer member and that contains a PTC material.

### BACKGROUND OF THE INVENTION

1. Field of the Invention

The invention relates to a temperature adjustment mechanism capable of restraining excessive temperature rise or excessive temperature drop of an electric power supply body.

2. Description of the Related Art

The vehicles that run by the drive force from an electric motor include hybrid motor vehicles, fuel cell vehicles, and electric motor vehicles. In these vehicles, a secondary cell or a capacitor (condenser) that stores electric power to be supplied to the electric motor is mounted. The performance and the service life of the secondary cell are greatly dependent on the ambient temperature. In particular, if the charging or discharging thereof is performed at high temperatures, the secondary cell can sometimes remarkably degrade.

Therefore, in order to restrain the degradation of the secondary cell, constructions for cooling the secondary cell have been proposed.

### SUMMARY OF THE INVENTION

The invention provides a temperature adjustment mechanism that restrains excessive temperature rise and excessive drop temperature of an electric power supply device, and also provides a vehicle equipped with the temperature adjustment mechanism.

A first aspect of the invention relates to a temperature adjustment mechanism. This temperature adjustment mechanism is characterized by including an electric power supply device, and a member that is provided between and in contact with the electric power supply device and a heat transfer member, and that contains a PTC material.

In the foregoing aspect, the member containing the PTC material may be a heat generation element.

In the foregoing aspect, the member containing the PTC material may be in contact with an entire surface of the electric power supply device that faces the heat transfer member.

Furthermore, in the foregoing aspect, the electric power supply device may have a case, an electric power supply body held within the case, a liquid held within the case, and a stirring member for use for stirring the liquid, and that the stirring member may be disposed at a position that faces the heat generator element via the case.

In the foregoing aspect, the heat generator element may be in contact with a region in a surface of the electric power supply device that faces the heat transfer member.

Furthermore, in the foregoing aspect, the temperature adjustment mechanism may further be provided with a support member that is provided between the electric power supply device and the heat transfer member at a region other than a region between the electric power supply device and the heat transfer member other than a region at which the electric power supply device contacts the heat generator element, and that supports the electric power supply device so that the electric power supply device remains apart from the heat transfer member.

In the foregoing aspect, the temperature adjustment mechanism may further be provided with control means for controlling the driving of the heat generator element based on a temperature of the electric power supply device, and the control means may cause the heat generator element to generate heat when the temperature of the electric power supply device is lower than a threshold. This restrains excessive temperature drop of the electric power supply device.

A second aspect of the invention relates to a vehicle. This vehicle is characterized by including a temperature adjustment mechanism according to the first aspect, wherein the heat transfer member is a vehicle main body.

According to the invention, the member containing the PTC material is disposed between the electric power supply device and the heat transfer member, so that if the electric power supply device generates heat, the heat can be transferred to the heat transfer member via the member containing the PTC material. This restrains excessive temperature rise of the electric power supply device.

Furthermore, in the case where the heat transfer member is excessively heated, the member containing the PTC material can trip so that the transfer of heat from the heat transfer member to the electric power supply device less easily occurs. Thus, excessive temperature rise of the electric power supply device can be restrained.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a sectional view schematically showing a temperature adjustment mechanism in accordance with Embodiment 1 of the invention;

FIG. 2 is a block diagram showing a construction that performs an operation control of the temperature adjustment mechanism in accordance with Embodiment 1;

FIG. 3 is a flowchart showing an operation control of the temperature adjustment mechanism in accordance with Embodiment 1;

FIG. 4 is a schematic diagram showing a construction of a temperature adjustment mechanism in accordance with Embodiment 2 of the invention;

FIG. 5 is a schematic diagram showing a construction of a stirring member; and

FIG. 6 is a schematic diagram showing an example of the arrangement of a battery pack in a comparative example.

### DETAILED DESCRIPTION OF EMBODIMENTS

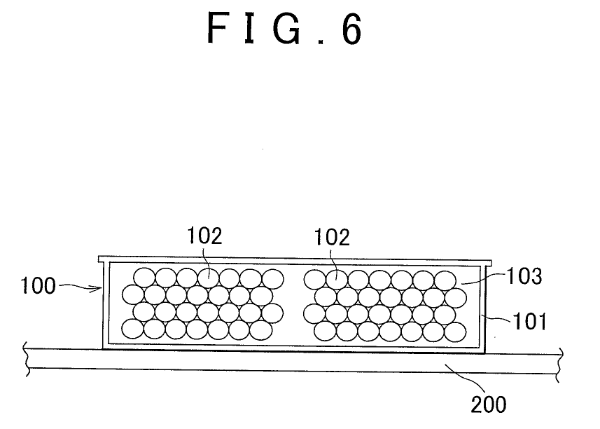

Before describing embodiments of the invention, a comparative example will be described. In a construction as shown in FIG. 6, a battery pack 100 in which a secondary cell 102 and a cooling liquid 103 are held in a case 101 is placed in contact with a vehicle main body (e.g., a floor panel) 200. In this construction, heat generated by the secondary cell 102 is transferred to the case 101 via the cooling liquid 103, and is released from the case 101 into the atmosphere or is transferred to the vehicle main body 200 that is in contact with the case 101. Therefore, the temperature rise of the secondary cell 102 can be restrained.

However, in the foregoing construction in which the battery pack 100 is placed in contact with the vehicle main body 200, drawbacks described below occur.

In the foregoing construction, since the battery pack 100 is always in contact with the vehicle main body 200, the battery pack 100 can sometimes be excessively cooled or excessively heated, depending on the ambient temperature.

For example, in winter, the temperature of the vehicle main body 200 sometimes reaches temperatures below the freezing point. In such a case, the battery pack 100 (secondary cell 102) in contact with the vehicle main body 200 is excessively cooled. In summer, due to temperature rises of the vehicle main body 200, the battery pack 100 in contact with the vehicle main body 200 is sometimes excessively heated.

The secondary cell can attain sufficient electric cell characteristics if the temperature is within a predetermined temperature range. If the temperature of the secondary cell is lower than a lower-limit value of the foregoing temperature range, or is higher than a higher-limit value thereof, sufficient electric cell characteristics cannot be attained.

Therefore, in the construction in which the battery pack 100 is merely disposed in contact with the vehicle main body 200, the excessive heating of the battery pack 100 sometimes occur so that sufficient electric cell characteristic cannot be achieved.

Embodiments 1 and 2 of the invention will be described below.

### Embodiment 1

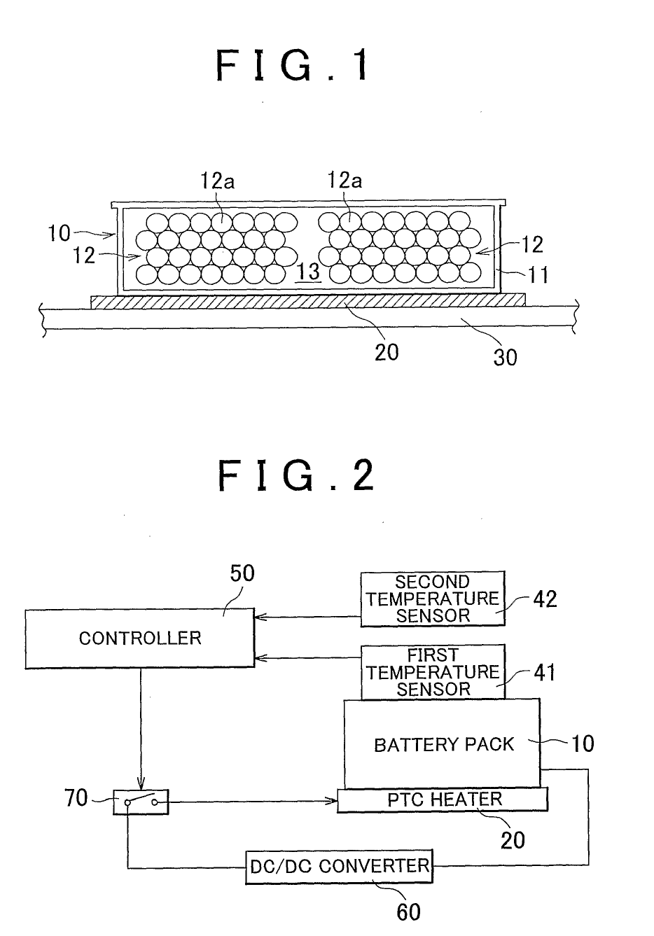

A temperature adjustment mechanism in accordance with Embodiment 1 of the invention will be described with reference to FIGS. 1 to 3.

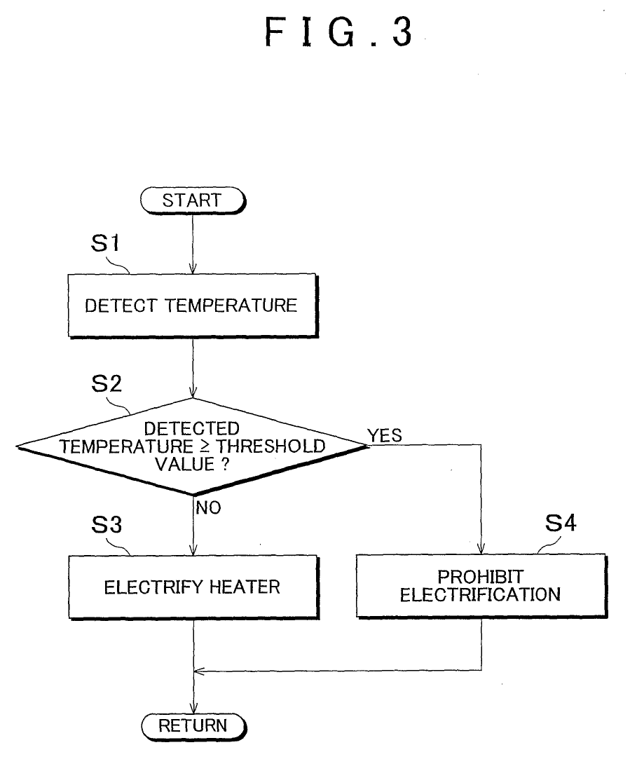

FIG. 1 is a sectional view schematically showing the temperature adjustment mechanism of a battery pack. FIG. 2 is a block diagram showing a construction that performs an operation control of the temperature adjustment mechanism, and FIG. 3 is a flowchart showing an operation control of the temperature adjustment mechanism. Incidentally, in FIGS. 1 to 3, the same members are represented by the same reference characters.

In FIG. 1, a battery pack (electric power supply device) 10 has a battery case 11, and a battery assembly (electric power supply body) 12 and a liquid 13 that are held within the battery case 11. The battery assembly 12 has a plurality of cylinder-shape electric cells 12a, and is clamped by a clamp member (not shown) from both end sides. Besides, the electric cells 12a are electrically connected in series by bus bars (not shown).

Wirings (not shown) for a positive electrode and a negative electrode are connected to the battery assembly 12. These wirings extend through the battery case 11, and are connected to electronic appliances (e.g., motors) that are disposed outside the battery case 11.

In this embodiment, the electric cells 12a are cylinder-shape secondary cells. Examples of the secondary cell include a nickel-hydride cell, a lithium ion cell, etc. In addition, the shape of the electric cells 12a is not limited to a cylinder shape, but may also be a different shape, such as a prism shape or the like. Besides, although this embodiment employs secondary cells, it is also possible to employ electric double-layer capacitors (condensers) or fuel cells instead of the secondary cells. The secondary cells and the like herein serve as an electric power supply for the aforementioned electronic appliances.

The liquid 13 is in contact with an outer peripheral surface of the battery assembly 12 and an inner wall surface of the battery case 11. If the battery assembly 12 generates heat due to charging or discharging or the like, the liquid 13 in contact with the battery assembly 12 restrains the temperature rise of the battery assembly 12 by undergoing heat exchange with the battery assembly 12. The liquid 13 after undergoing the heat exchange with the battery assembly 12 contacts the inner wall surface of the battery case 11 due to natural convection within the battery case 11. As a result, heat of the liquid 13 is transferred to the battery case 11.

Although in this embodiment, the liquid 13 in the battery case 11 is naturally convected by utilizing temperature differences, this is not restrictive. For example, a stirring member for forcing the liquid 13 to flow may be disposed in the battery case 11.

The liquid 13 used herein may be an insulating oil, an inert liquid. The insulating oil used herein is, for example, silicon oil. Besides, the inert liquid used herein may be Fluorinert, Novec HFE (hydrofluoroether), Novec 1230® (made by 3M), which are each a fluorine-based inert liquid.

Furthermore, although in this embodiment a liquid is used as the coolant, it is also possible to use a gas, such as air, nitrogen gas, etc., as a coolant, instead of a liquid.

The battery pack 10 constructed as described above is mounted in a vehicle, and supplies (discharges) electric power to electric motors or the like in the vehicle, or recovers (charges) regenerative energy that is generated during deceleration of the vehicle or the like.

A sheet-shape PTC (Positive Temperature Coefficient) heater (heat generator element) 20 is disposed between a bottom surface of the battery pack 10 and a vehicle main body (heat transfer member) 30. Specifically, the PTC heater 20 is, at a side surface thereof, in contact with the entire bottom surface of the battery pack 10, and at another side surface in contact with a surface of the vehicle main body 30.

Examples of the vehicle main body 30 herein include a floor panel, and a frame of the vehicle.

In the PTC heater 20, if a constant voltage is applied thereto, a current according to the initial resistance flows, so that the temperature thereof rises due to its self-heating. Then, when the temperature of the PTC heater 20 reaches the Curie temperature, the resistance thereof sharply increases, and therefore the current through the PTC heater 20 sharply decreases. Furthermore, if the temperature of the PTC heater 20 reaches the Curie temperature due to heat from the vehicle main body 30, the transfer of heat from the vehicle main body 30 to the battery pack 10 via the PTC heater 20 less easily occurs. This phenomenon will be referred to as “the PTC heater 20 trips” hereinafter. Further, in the embodiment, in the PTC heater 20 shown in FIG. 1, heating elements are disposed in parallel, and an electric current is supplied in parallel to the heating elements, although not shown in the drawings.

The PTC heater 20 used herein may be, for example, a ceramic obtained by adding a rare earth element as an additive to high-purity barium titanate (BaTiO₃) for conversion to a semiconductor, and adding a very small amount of Mn, Cr, B or the like as an additive for a resistance sharp change characteristic, and then sintering the mixture. Furthermore, the Curie temperature can be arbitrarily set within a range of about −20 to 300° C. by appropriately setting the material composition and quantities.

As shown in FIG. 2, the battery pack 10 is provided with a first temperature sensor 41. A controller (control means) 50 is able to receive an output of the first temperature sensor 41 and acquires (detects) therefrom temperature information about the battery pack 10.

It suffices that the first temperature sensor 41 be able to directly or indirectly detect the temperature of the battery assembly 12. For example, the first temperature sensor 41 may be placed in the direct contact with the battery assembly 12 within the battery case 11 so as to detect the temperature of the battery assembly 12, or the first temperature sensor 41 may also be placed in contact with the liquid 13 within the battery case 11 so as to indirectly detect the temperature of the battery assembly 12.

A second temperature sensor 42 is a sensor for detecting the temperature of the vehicle main body 30, and outputs a result of the detection to the controller 50. It suffices that the second temperature sensor 42 be able to directly or indirectly detect the temperature of the vehicle main body 30.

The second temperature sensor 42 may be an existing sensor that is provided in the vehicle. Besides, the temperature of the vehicle main body 30 may also be estimated on the basis of the temperature adjustment state of an airconditioner in a vehicle cabin. In this case, there is no need to provide the second temperature sensor 42.

The controller 50 is able to control appliances and the like that are mounted in the vehicle so that the vehicle assumes a desired operation state, in addition to controls described below.

The output (high voltage) of the battery pack 10 (battery assembly 12) is output to a DC/DC converter 60, and is converted into a predetermined voltage (low voltage) at the DC/DC converter 60. A switch circuit 70 is provided between the DC/DC converter 60 and the PTC heater 20. The switch circuit 70, upon receiving a control signal from the controller 50, changes from one of an on-state and an off-state to the other.

When the switch circuit 70 is in the on-state, the output of the DC/DC converter 60 is input to the PTC heater 20. When the switch circuit 70 is in the off-state, the electrification of the PTC heater 20 is discontinued. Therefore, the PTC heater 20 can be heated, the heat generation thereof can be stopped.

Although in the embodiment, the PTC heater 20 is driven by using the electric power from the battery pack 10 (battery assembly 12), the PTC heater 20 may also be driven by using another electric power supply that is provided in the vehicle. Examples of the another electric power supply used herein include a battery that outputs a voltage of 12 V (so called auxiliary battery).

Furthermore, although in the embodiment the high voltage of the battery assembly 12 is converted into a low voltage by using the DC/DC converter 60, the output of the battery assembly 12 may also be input directly to the PTC heater 20.

Next, a control operation of the controller 50 will be described through the use of a flowchart as shown in FIG. 3. Although in the embodiment, the electrification control of the PTC heater 20 associated with change in temperature of the battery pack 10 and the electrification of the PTC heater 20 associated with change in temperature of the vehicle main body 30 are separately performed, these controls are the same operation, and therefore will be described altogether.

In step S1, the controller 50 receives an output signal of the first temperature sensor 41, and acquires temperature information about the battery pack 10. Furthermore, the controller 50 also receives an output signal of the second temperature sensor 42, and acquires temperature information about the vehicle main body 30.

In step S2, the controller 50 determines whether or not the temperature detected by the first temperature sensor 41 is higher than or equal to a threshold value. If the detected temperature is higher than or equal to the threshold value, the process proceeds to step S4. If the detected temperature is lower than the threshold value, the process proceeds to step S3.

Besides, the controller 50 also determines whether or not the temperature detected by the second temperature sensor 41 is higher than or equal to a threshold value. If the detected temperature is higher than or equal to the threshold value, the process proceeds to step S4. If the detected temperature is lower than the threshold value, the process proceeds to step S3.

Each of the threshold values is a temperature that adversely affects the electric cell characteristic of the battery pack 10 (the battery assembly 12) due to excessive cooling. Each of the threshold values can be set on the basis of a lower limit value of a proper temperature range of the battery assembly 12, and can be set at, for example, 0° C.

Incidentally, the temperature of the battery pack 10 and the temperature of the vehicle main body 30 mostly exhibit values that are substantially approximate to each other. However, the temperature of the vehicle main body 30 may become extremely lower than the temperature of the battery pack 10, for example, in an environment of winter or the like. Besides, in an environment of summer or the like, the temperature of the vehicle main body 30 may become extremely higher than the temperature of the battery pack 10.

In step S3, the controller 50 electrifies the PTC heater 20 by turning on the switch circuit 70. As a result, the PTC heater 20 generates heat, so that the battery pack 10 and the vehicle main body 30 are heated.

That is, if the temperature of the battery pack 10 is lower than the threshold value, the electric cell characteristic of the battery assembly 12 may sometimes degrade. In such a case, however, the temperature drop of the battery pack 10 (the battery assembly 12) can be restrained by heating the battery pack 10 via the PTC heater 20. As a result, the battery assembly 12 can be caused to maintain a desired electric cell characteristic.

Furthermore, if the vehicle main body 30 is excessively cooled, for example, in winter, the battery pack 10 disposed on the vehicle main body 30 may also sometimes be excessively cooled. Therefore, in this embodiment, even when the vehicle main body 30 is excessively cooled, the excessive cooling of the battery pack 10 is restrained by causing the PTC heater 20 to generate heat.

In step S4, the controller 50 prohibits the electrification of the PTC heater 20 by turning off the switch circuit 70. In the case where the battery assembly 12 has been heated due to charging/discharging or the like, heat is transferred to the battery case 11 via the liquid 13 as described above. Then, the heat transferred to the battery case 11 is released from outer surfaces of the battery case 11 into, the atmosphere, or is transferred to the vehicle main body 30 via the PTC heater 20.

In this case, since the PTC heater 20 is not heated, the heat generated by the battery assembly 12 is mostly transferred to the vehicle main body 30 via the PTC heater 20. Therefore, the temperature rise of the battery assembly 12 can be restrained, and the degradation of the electric cell characteristic associated with the temperature rise can be restrained.

An example of the electrification control for the PTC heater 20 according to the temperature of the vehicle main body 30 or the battery pack 10 (the battery assembly 12) is shown in Table 1.

TABLE 1

| | | | | | |
|---|---|---|---|---|---|
| Temperature | −30 | 0 | 20 | 60 | 80 |
| of vehicle | | | | | |
| main body | | | | | |
| (° C.) | | | | | |
| Temperature | −30 | 0 | 20 | 60 | |
| of battery pack | | | | | |
| (° C.) | | | | | |
| Electrification | Electri- | Electri- | Not | Not | Not |
| of PTC heater | fied | fied | electrified | electrified | electrified |
| | (ON) | (ON) | (OFF) | (OFF) | (OFF) |
| Trip of PTC | — | — | — | — | Trip |
| heater | | | | | |

As shown in Table 1, the threshold value described above in conjunction with step S2 is set at a value in the range of 0 to 20° C.

As shown in Table 1, if the temperature of the vehicle main body 30 reaches a high temperature (80° C.), the PTC heater 20 trips because the PTC heater 20 receives heat from the vehicle main body 30. That is, as described above, the rate of the heat transfer via the PTC heater 20 drops, and therefore the transfer of heat from the vehicle main body 30 to the battery pack 10 less easily occurs.

Thus, by restraining the heat that the battery pack 10 receives from the vehicle main body 30, the temperature rise of the battery pack 10 can be restrained, and the degradation of the electric cell characteristic of the battery assembly 12 can be restrained.

On the other hand, if the temperature of the battery pack 10 is 0° C. or −30° C., the PTC heater 20 is electrified, and the battery pack 10 is warmed by the generation of heat of the PTC heater 20. Therefore, it is possible to restrain the excessive cooling of the battery pack 10 (the battery assembly 12) and therefore restrain the deterioration of the electric cell characteristic.

The use of the PTC heater 20 as in this embodiment attains effects as described below.

That is, the PTC heater 20, having the foregoing characteristics, is able to heat only a region whose temperature has dropped. Therefore, even in a construction in which the PTC heater 20 is placed in contact with the entire bottom surface of the battery pack 10 as in the embodiment, it is possible to warm only a portion of the battery pack 10 that is cold. As a result, the entire surface of contact with the battery pack 10 can be substantially uniformly warmed.

Furthermore, since the PTC heater 20 is able to generate heat rapidly upon electrification, it is possible to shorten the time that is taken to bring the temperature of the battery pack 10 to a specific temperature. Furthermore, if the temperature of the vehicle main body 30 is higher than or equal to a predetermined temperature (80° C. in the embodiment), the PTC heater 20 trips as described above, whereby the heat transfer between the vehicle main body 30 and the battery pack 10 can be restrained, and the excessive cooling of the battery pack 10 can be restrained.

Incidentally, although in the embodiment, the temperature of the battery pack 10 (the battery assembly 12) and the temperature of the vehicle main body 30 are detected, it is permissible to detect only the temperature of the battery pack 10. Specifically, in the case where the vehicle main body 30 is excessively cooled, there is possibility of the battery pack 10 also being excessively cooled as described above. However, if the temperature of the battery pack 10 is monitored, the PTC heater 20 can be caused to generate heat before the temperature of the battery pack 10 extremely drops.

Furthermore, although in the embodiment, the battery pack 10 is disposed on the vehicle main body 30 with the PTC heater 20 interposed therebetween, this is not restrictive. For example, in a construction in which the battery pack 10 is disposed on another member (a so-called heat transfer member) that is placed in contact with the vehicle main body 30, the PTC heater 20 may be disposed between the another member and the battery pack 10.

Furthermore, although in the embodiment, the PTC heater 20 having a function as a heat generator element is used, it is also possible to use a PTC heater that does not have a function as a heat generator element. Specifically, the battery pack 10 may also be disposed on the vehicle main body 30 with an interposed member that contains a PTC material. Therefore, as described above, if the temperature of the member containing a PTC material becomes higher than a predetermined value due to heat from the vehicle main body 30, the heat conductivity of the member containing the PTC material drops. Thus, it is possible to prevent the battery pack 10 from being excessively heated by the excessive heat of the vehicle main body 30.

### Embodiment 2

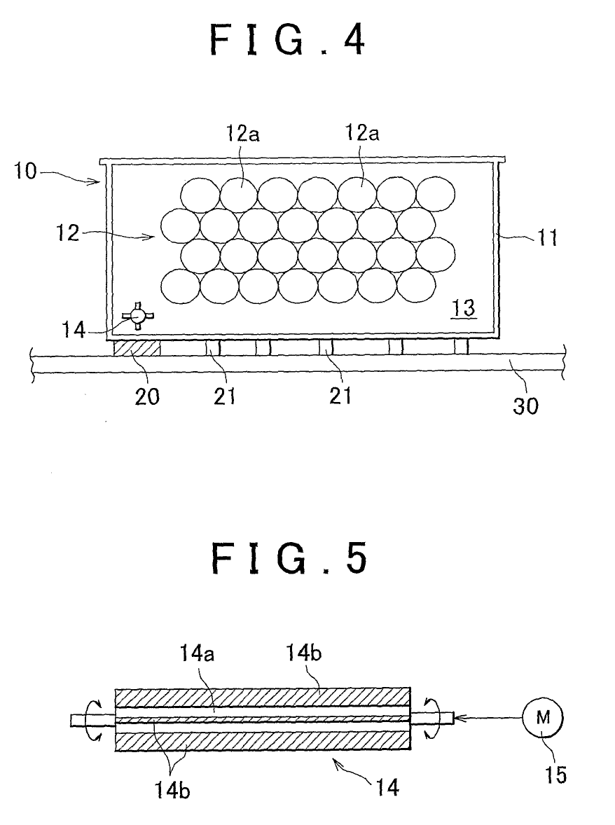

A temperature adjustment mechanism in accordance with Embodiment 2 of the invention will be described with reference to FIG. 4. FIG. 4 is a schematic diagram showing a construction of a temperature adjustment mechanism of the embodiment. Incidentally, the members that have the same functions as the members described above in conjunction with Embodiment 1 are represented by the same reference characters.

In this embodiment, the battery pack 10 has a battery case 11, and a battery assembly 12 and a liquid 13 that are held in the battery case 11, as in Embodiment 1.

Furthermore, a stirring member 14 for stirring the liquid 13 within the battery case 11 is disposed within the battery case 11. The stirring member 14, as shown in FIG. 5, has a shaft portion 14a that extends along a wall surface of the battery case 11, and stirring blades 14b that are formed on a surface of the shaft portion 14a.

The stirring member 14 is not limited to the construction as shown in FIG. 5, but may have any construction as long as the construction allows the liquid 13 to be circulated within the battery case 11.

The stirring member 14 is linked to an electric motor 15, and can be rotated by power from the electric motor 15. The electric motor 15 can be supplied with electric power from the battery assembly 12 or from another electric power supply. The electric motor 15 used herein may be an electromagnetic motor or the like. If an electromagnetic motor is used, the stirring member 14 can be driven without the need to form an opening portion in a wall surface of the battery case 11.

A sheet-shape PTC heater 20 is disposed, as shown in FIG. 4, between a vehicle main body 30 and a region in the battery case 11 in which the stirring member 14 is provided. Furthermore, a plurality of support members 21 for supporting the battery case 11 are disposed between the vehicle main body 30 and a region in the battery case 11 that is other than the region in which the stirring member 14 is disposed.

That is, in this embodiment, since the PTC heater 20 whose area is smaller than the area of the bottom surface of the battery pack 10 is disposed between the battery pack 10 and the vehicle main body 30, the support members 21 having a height that corresponds to the thickness of the PTC heater 20 is provided, so that the battery pack 20 is disposed generally parallel to the vehicle main body 30.

In this embodiment, the driving of the PTC heater 20 is controlled by the controller 50 as in Embodiment 1 (see FIGS. 2 and 3). Specifically, if the temperature of the battery pack 10 is lower than a threshold value, the controller 50 electrifies the PTC heater 20. If the temperature of the battery pack 10 is higher than or equal to the threshold value, the controller 50 discontinues the electrification of the PTC heater 20. Besides, it is also permissible that the temperature of the vehicle main body 30 be detected, and when the vehicle main body 30 is excessively cooled, the PTC heater 20 be electrified.

The stirring member 14 within the battery case 11 may be kept rotated all the time, or may also be rotated according to the electrification of the PTC heater 20. If the stirring member 14 is kept rotated all the time, the battery assembly 12 heated by the charging/discharging or the like can be efficiently cooled. Furthermore, if the stirring member 14 is rotated according to the electrification of the PTC heater 20, the electric power consumption associated with the driving of the PTC heater 20 can be restrained.

In this embodiment, the electrification and the non-electrification of the PTC heater 20 are selectively performed according to the temperature of the battery pack 10, and therefore substantially the same effects as in Embodiment 1 can be achieved.

In this embodiment, since the stirring member 14 is disposed in a portion of the battery case 11 that is near the PTC heater 20, the liquid heated by the PTC heater 20 can be caused to flow in the entire battery case 11 by rotating the stirring member 14. Therefore, if the battery pack 10 is cool, the battery pack 10 can be efficiently warmed. Besides, as compared with Embodiment 1, the PTC heater 20 be reduced in size, so that the cost increase can be restrained.

Incidentally, it suffices that the stirring member 14 be disposed at such a position as to efficiently cause the liquid 13 warmed by the PTC heater 20 to flow within the battery case 11. It is not altogether necessary that the stirring member 14 be provided directly over the PTC heater 20 as shown in FIG. 4.

Furthermore, in this embodiment, by using the support members 21, the bottom surface of the battery pack 10 is made apart from the upper surface of the vehicle main body 30. Specifically, an air layer is formed between the battery pack 10 and the vehicle main body 30. As a result, in the case where the vehicle main body 30 is excessively cooled or heated, the excessive cooling or heating of the battery pack 10 can be restrained.

1.-9. (canceled)

10. A temperature adjustment mechanism, comprising:
an electric power supply device;
a member that is provided between and in contact with the electric power supply device and a heat transfer member, and that contains a PTC material; and
a support member that is provided between the electric power supply device and the heat transfer member at a region other than a region at which the electric power supply device contacts a heat generator element that is the member containing PTC material, and that supports the electric power supply device so that the electric power supply device remains apart from the heat transfer member, wherein:
the electric power supply device has a case, an electric power supply body held within the case, a liquid held within the case, and a stirring member for stirring the liquid; and
the stirring member is disposed at a position that faces the heat generator element via the case.

11. The temperature adjustment mechanism according to claim 10, further comprising:
A control device to control the driving of the heat generator element based on a temperature of the electric power supply device.

12. The temperature adjustment mechanism according to claim 11, wherein the control device drives the heat generator element when at least one of the temperatures of the electric power supply device and the temperature of the heat transfer member is lower than a predetermined temperature.

13. The temperature adjustment mechanism according to claim 10, wherein the electric power supply body is a secondary cell or a capacitor.

14. A vehicle, comprising:
a temperature adjustment mechanism comprising:
an electric power supply device;
a member that is provided between and in contact with the electric power supply device and a heat transfer member, and that contains a PTC material; and
a support member that is provided between the electric power supply device and the heat transfer member at a region other than a region at which the electric power supply device contacts a heat generator element that is the member containing PTC material, and that supports the electric power supply device so that the electric power supply device remains apart from the heat transfer member, wherein:
the electric power supply device has a case, an electric power supply body held within the case, a liquid held within the case, and a stirring member for stirring the liquid;
the stirring member is disposed at a position that faces the heat generator element via the case; and
the heat transfer member is a vehicle main body.
